(19) United States
(12) Patent Application Publication
(10) Pub. No.: US 2024/0310630 A1
(43) Pub. Date: Sep. 19, 2024

(54) FOVEATED OPTICAL LENS FOR NEAR EYE DISPLAY

(71) Applicant: 3M INNOVATIVE PROPERTIES COMPANY, Saint Paul, MN (US)

(72) Inventors: Timothy L. Wong, West St. Paul, MN (US); John D. Le, Woodbury, MN (US); David J.W. Aastuen, Shoreview, MN (US)

(21) Appl. No.: 18/274,303

(22) PCT Filed: Feb. 15, 2022
(86) PCT No.: PCT/IB2022/051334

§ 371 Date: Jul. 26, 2023

Related U.S. Application Data
(60) Provisional application No. 63/200,142, filed on Feb. 17, 2021.

(51) Int. Cl. G02B 27/01; G02B 17/08

(52) U.S. Cl. CPC G02B 27/0172; G02B 17/0804; G02B 2027/0125

(57) ABSTRACT

An optical system includes an optical system axis, a display and at least one lens, the optical system forming a virtual image of an image emitted by the display for viewing by an eye, the eye having an optical eye axis, such that a first retinal image of the virtual image at a first virtual image location and an associated first field angle, the first field angle between about 5 degrees and about 30 degrees, has a first image resolution when the eye axis is substantially coincident with the system axis, and a second image resolution when the eye is rotated so that the eye axis is substantially coincident with a first field axis extending between the eye and the virtual image at the first field angle, wherein the second image resolution is greater than the first image resolution.

### SUMMARY

In some aspects of the present description, an optical system is provided, the optical system including an optical system axis, a display, and at least one lens. The optical system forms a virtual image of an image emitted by the display for viewing by an eye. The eye has an optical eye axis such that a first retinal image of the virtual image at a first virtual image location and an associated first field angle, the first field angle between about 5 degrees and about 30 degrees, has a first image resolution when the eye axis is substantially coincident with the system axis, and a second image resolution when the eye is rotated so that the eye axis is substantially coincident with a first field axis extending between the eye and the virtual image at the first field angle. The second image resolution is greater than the first image resolution.

In some aspects of the present description, an optical system is provided, the optical system including an optical system axis, a lens assembly having at least one lens, an eye-side configured to be disposed proximate an eye of a viewer, and a display-side configured to be disposed proximate a display. The optical system is configured to display a virtual image of an image emitted by the display to the eye of the viewer. When a substantially collimated light that propagates along a first direction making a first angle of between about 5 degrees and about 30 degrees with the system axis illuminates the optical system from the eye-side of the optical system and enters the optical system through, and substantially fills, a field stop positioned proximate the eye-side of the optical system, and focuses to a focal spot after going through the lens assembly and exiting the optical system from the display-side thereof, the focal spot has a first minimum size when the field stop is substantially centered on the system axis and a second minimum size when the field stop is rotated about a first center proximate a center of the eye of the viewer so that the field stop is substantially perpendicular to the first direction, the second minimum size being smaller than the first minimum size.

In some aspects of the present description, an optical system is provided, the optical system including an optical system axis, a display, and at least one lens. The optical system forms a virtual image of an image emitted by the display for viewing by an eye when the eye is positioned proximate an eye-location on an eye-side of the optical system. For each first virtual image location at a first field angle of between about 5 degrees and about 30 degrees relative to the system axis, when an imaging system (e.g., a camera with an objective lens) centered on an imaging system axis is positioned proximate the eye-location and forms an image of the virtual image corresponding to the first virtual image location, a resolution of the formed image increases as the imaging system is at least rotated so that the imaging system axis approaches the first field angle.

In some aspects of the present description, an optical system is provided, the optical system including an optical system axis, a display, at least one lens, a partial reflector, and a reflective polarizer. The optical system forms a virtual image of an image emitted by the display for viewing by an eye. The eye has an optical eye axis extending from a center of a fovea of the eye to a center of a pupil of the eye. A first retinal image of the virtual image at a first virtual image location and an associated first field angle of between about 5 degrees and about 30 degrees, has a first image resolution when the eye axis is substantially coincident with the system axis, and has a second image resolution when the eye is rotated so that the eye axis is substantially coincident with a first field axis. The first field axis extends between the eye and the virtual image at the first field angle. The second image resolution is greater than the first image resolution.

### BRIEF DESCRIPTION OF THE DRAWINGS

FIG. 1 is a side view of an optical system including a foveated optical lens, in accordance with an embodiment of the present description;

FIGS. 2A and 2B provide visual depictions of optical axes for an optical system, in accordance with an embodiment of the present description;

FIG. 3 provides a side view of a foveated optical lens, in accordance with an embodiment of the present description;

FIG. 4 provides an alternate view of the foveated optical lens of FIG. 3, in accordance with an embodiment of the present description;

FIGS. 5A and 5B provide side views of an optical system including an imaging system, in accordance with an embodiment of the present description;

FIGS. 6A and 6B provide details on an optical system including lenses with defined surface curves, in accordance with an embodiment of the present description;

FIGS. 7A and 7B provide additional definition for the lens surfaces of FIGS. 6A and 6B, in accordance with an embodiment of the present description; and

FIGS. 8A and 8B provide additional details for the lens surfaces of FIGS. 6A and 6B, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Near Eye Displays (e.g., head-mounted displays, wearable displays, virtual reality headsets) are used to create a virtual image in the field of view of one or both eyes. A near eye display creates a virtual image in such a way that the image appears at a distance (e.g., displayed out in front of a user) and seems larger than the actual image generated by the corresponding small display creating the virtual image. Key performance metrics for optical lenses used in near eye displays include gaze resolution, pupil swim (image distortion as your eye moves around the lens), image contrast, and ghosting (unwanted images caused by reflections from the surfaces of a lens). While the lens in a pair of eyeglasses can be designed to provide the best optical characteristics for a chosen viewing angle and distance (e.g., focusing on a computer display at arm's length), the same methods may not work as well for a head-mounted virtual reality (VR) headset. This is because a VR system requires a wide field of view (e.g., greater than 85-degree field of view), and eye rotation over that wide field of view can cause image issues. For example, as the pupil of the eye moves over the larger field of view, the image may lose sharpness or resolution when the gaze moves off the main optical axis (e.g., gazing up and to the left).

According to some aspects of the present description, an optical system is configured to provide optimal viewing characteristics over a large field of view. This may be done, for example, by designing a lens or lens assembly within the optical system wherein the lens components and surfaces are configured to provide equal or increasing retinal image resolution when the eye of the user is rotated at an angle with the optical system axis (e.g., at an upward angle of between about 5 degrees and about 30 degrees with the optical system axis) as compared to the retinal image resolution when the eye is substantially aligned with the optical system axis. In some embodiments, the optical system includes an optical system axis, a display, and at least one lens. In some embodiments, the optical system may form a virtual image of an image emitted by the display for viewing by an eye. In some embodiments, the eye may have an optical eye axis such that a first retinal image of the virtual image at a first virtual image location and an associated first field angle between about 5 degrees and about 30 degrees may have a first image resolution when the eye axis is substantially coincident with the system axis, and a second image resolution when the eye is rotated so that the eye axis is substantially coincident with a first field axis extending between the eye and the virtual image at the first field angle. In some embodiments, the second image resolution is greater than the first image resolution. In some embodiments, the second image resolution may be greater than the first image resolution for all first field angles between about 5 degrees and about 30 degrees.

In some embodiments, the optical system may further include one or more of a partial reflector (e.g., a 50/50 beamsplitter layer or coating), a reflective polarizer, and an optical retarder (e.g., a quarter-wave plate). In some embodiments, the optical system axis may be a folded optical axis. In some embodiments, the optical system axis may be folded so that a first segment of the optical system axis substantially coincides with a different second segment of the optical system axis. For example, in some embodiments, the at least one lens may be a lens assembly with at least a first display-side lens component and a second eye-side lens component. A partial reflector may be disposed on a side of the display-side lens component closest to the display. An optical retarder may be disposed between the display-side lens component and the eye-side lens component. A reflective polarizer may be disposed on a side of the eye-side lens component closed to the eye of an observer. In such an embodiment, the optical axis may pass from the display, through the partial reflector and the optical retarder, be reflected off of the reflective polarizer, back through the optical retarder, and then reflected off of the partial reflector, back through the optical retarder and the reflective polarizer (as the polarization state has now changed after passing through the optical retarder three times) and finally leaves the eye-side lens component through the reflective polarizer toward the eye of the observer.

For the purposes of this specification, the terms “optical system axis”, “system axis”, and “optical axis” are synonymous, and these terms shall be defined to mean an imaginary line defining a path along which light propagates through an optical system and around which the light path exhibits some degree of rotational symmetry. In some embodiments, an optical system axis may be folded (i.e., light may pass through, be reflected by, be refracted by, or otherwise affected by one or more optical components (e.g., lenses, optical films, optical retarders, etc.) such that the path of the light is folded rather than strictly linear). However, even in a system with a folded optical axis, as used herein, these terms shall be defined to be the imaginary line along which there is rotational symmetry in an optical system.

In some embodiments, the at least one lens may include a first optical lens with opposing first and second major surfaces, and a second optical lens with opposing third and fourth major surfaces. In some embodiments, the second and third major surfaces may face each other. In some embodiments, the first through fourth major surfaces may have respective sags S1-S4, where each of the sags is defined by the following equation:

$$S = \frac{c {r}^{2}}{1 + \sqrt{1 - ( 1 + k ) {c}^{2} {r}^{2}}} + {α}_{2} {r}^{4} + {α}_{3} {r}^{6} + {α}_{4} {r}^{8}$$

where c is 1/radius of curvature of the major surface, k is the conic constant of the surface, r is a distance from the optic axis, and a is an aspheric deformation constant. In some embodiments, the first major surface may have a convex central portion surrounded by an annular concave outer portion, and the second major surface may be convex. In some embodiments, the third major surface may be substantially planar, and the fourth major surface may be convex. In some embodiments, for a value of r extending from about 1 mm to at least about 25 mm, the following conditions may be true:
−0.7 is less than or equal to S1/S2, and S1/S2 is less than or equal to 1,
−0.2 is less than or equal to S1/S4, and S1/S4 is less than or equal to 0.4, and
a best fourth-order polynomial fit to each of the S1/S2 and S1/S4 has an r-squared value greater than about 0.95.

According to some aspects of the present description, an optical system may include an optical system axis, a lens assembly having at least one lens, an eye-side configured to be disposed proximate an eye of a viewer, and a display-side configured to be disposed proximate a display (e.g., a light-emitting diode display, a liquid crystal display, an organic LED display, etc.). In some embodiments, the optical system may be configured to form a virtual image of an image emitted by the display to be observed by a viewer (e.g., the virtual image is viewed when the user is wearing a VR headset). In some embodiments, when a substantially collimated light that propagates along a first direction making a first angle of between about 5 degrees and about 30 degrees with the system axis illuminates the optical system from the eye-side of the optical system and enters the optical system through, and substantially fills, a field stop positioned proximate the eye-side of the optical system, and focuses to a focal spot after going through the lens assembly and exiting the optical system from the display-side thereof, the focal spot may have a first minimum size when the field stop is substantially centered on the system axis. The focal spot may have a second minimum size when the field stop is rotated about a first center proximate a center of the eye of the viewer so that the field stop is substantially perpendicular to the first direction. In some embodiments, the second minimum size is smaller than the first minimum size. In some embodiments, the field stop may have a size of between about 1 millimeter (mm) and about 10 mm, or between about 2 mm and about 9 mm, or between about 2 mm and about 8 mm, or between about 2 mm and about 7 mm, or between about 3 mm and about 7 mm. In some embodiments, the optical system may further include one or more of a partial reflector, a reflective polarizer, and an optical retarder.

According to some aspects of the present description, an optical system may include an optical system axis, a display, and at least one lens. In some embodiments, the at least one lens may include a first lens which is a Fresnel lens with a structured major surface. In some embodiments, the optical system may further include a partial reflector, a reflective polarizer, and an optical retarder. In some embodiments, the optical system may form a virtual image of an image emitted by the display for viewing by an eye when the eye is positioned proximate an eye-location on an eye-side of the optical system (e.g., positioned near a near eye display in a VR headset). In some embodiments, for each first virtual image location at a first field angle of between about 5 degrees and about 30 degrees relative to the system axis, when an imaging system centered on an imaging system axis is positioned proximate the eye-location and forms an image of the virtual image corresponding to the first virtual image location, a resolution of the formed image may increase as the imaging system is at least rotated so that the imaging system axis approaches the first field angle.

According to some aspects of the present description, an optical system may include an optical system axis, a display, at least one lens, a partial reflector, and a reflective polarizer. In some embodiments, the optical system may be configured to form a virtual image of an image emitted by the display to be observed by a viewer (e.g., the virtual image is viewed when the user is wearing a virtual reality headset). In some embodiments, the eye may have an optical eye axis extending from a center of a fovea of the eye to a center of a pupil of the eye. The fovea, or fovea centralis, is a small pit in the back surface of the eye composed of closely packed cones, and is responsible for sharp central vision (i.e., foveal vision). Foveal vision provides the highest resolution in the eye (e.g., important for perceiving high visual detail). In some embodiments, a first retinal image of the virtual image at a first virtual image location and an associated first field angle of between about 5 degrees and about 30 degrees, may have a first image resolution when the eye axis is substantially coincident with the system axis, and has a second image resolution when the eye is rotated so that the eye axis is substantially coincident with a first field axis. In some embodiments, the first field axis may extend between the eye and the virtual image at the first field angle. In some embodiments, the second image resolution may be greater than the first image resolution.

In some embodiments, the optical system may further include one or more of a partial reflector, a reflective polarizer, and an optical retarder. In some embodiments, the optical system axis may be folded. For example, in some embodiments, the optical system axis may be folded so that a first segment of the system axis substantially coincides with a different second segment of the system axis. In some embodiments, the presence of one or more optical layers (e.g., a partial reflector, a reflective polarizer, an optical retarder, etc.) may aid in creating the folded optical system axis.

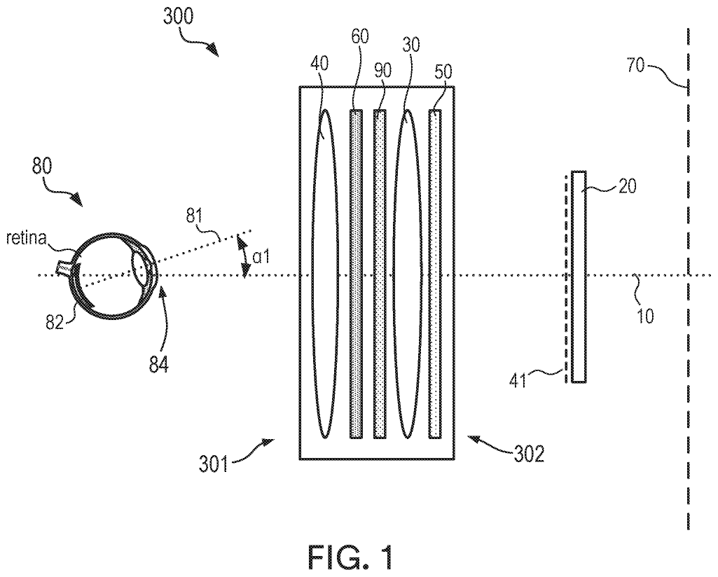

Turning to the drawings, FIG. 1 is a side view of an optical system including a foveated optical lens, according to the present description. In some embodiments, optical system 300 includes a display 20, an optical system axis 10, and at least one lens (e.g., such as lenses 30/40). In some embodiments, lenses 30 and 40 may be separate lens components in a lens assembly. In some embodiments, the optical system may further include one or more of a partial reflector 50 (e.g., a 50/50 beamsplitter coating or film), a reflective polarizer 60, and an optical retarder 90 (e.g., a quarter-wave plate).

In some embodiments, optical system 300 forms a virtual image 70 of an image 41 emitted by display 20. The virtual image 70 may be viewed by an eye 80 of an observer as a first retinal image 82 on the retina of eye 80. Eye 80 may have an optical axis 81. The eye 80 may be rotated at times such that optical axis 81 of eye 80 is substantially in line with optical system axis 10, and eye 80 may be rotated at times such that optical axis 81 is not aligned with optical system axis 10 (e.g., eye 80 may be rotated up by angle α1, as shown in FIG. 1, so that the observer is looking at a higher point on virtual image 70).

Optical system 300 may have an eye-side 301, substantially facing eye 80, and a display-side 302, facing away from eye 80 and facing display 20. Optical system 300 may be configured to provide the virtual image 70 to eye 80 optimally when eye 80 is positioned proximate eye-location 84. In some embodiments, the resolution of the retinal image 82 formed on the retina of eye 80 may be greater when the optical axis 81 is rotated by angle α1 than the resolution of the retinal image 82 when the optical axis 81 is substantially aligned with optical system axis 10. In some embodiments, angle α1 may be between about 5 degrees and about 30 degrees.

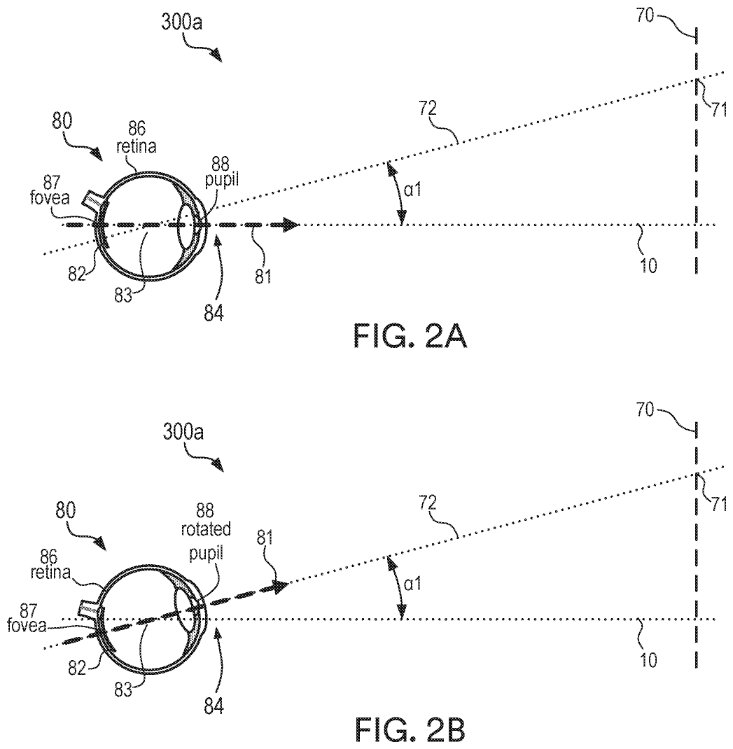

FIGS. 2A and 2B provide visual depictions of optical axes for the optical system of FIG. 1, providing additional details. For simplicity, the at least one lens and the display shown in FIG. 1 have been omitted in FIGS. 2A and 2B, and, accordingly, the partial optical system shown is relabeled 300a. Components shown in FIGS. 2A and 2B have a common function and/or purpose as like-numbered components in other figures herein unless otherwise specified. FIG. 2A shows an eye 80 of an observer located proximate eye-location 84 (i.e., a location for which the optical system is configured to provide optical resolution for the entire field of view), and with an optical eye axis 81 extending from a center of a fovea 87 of the eye 80, through the center 83 of eye 80, to the pupil 88. In operation, a retinal image 82 of virtual image 70 is formed on the retina 86. In FIG. 2A, optical eye axis 81 is positioned such that it is substantially aligned with optical system axis 10 (i.e., eye 80 is rotated to be looking directly along, or substantially parallel to, optical system axis 10).

In FIG. 2B, eye 80 is rotated up, such that optical eye axis 81 is now substantially aligned with a first field axis 72 extending between the eye 80 and a first virtual image location 71. In some embodiments, first field axis 72 creates a first field angle α1 with the optical system axis 10. In some embodiments, first field angle α1 may be between about 5 degrees and about 30 degrees.

In some embodiments, the first retinal image 82 has a first image resolution of a first virtual image location 71 when optical eye axis 81 is substantially coincident with optical system axis 10, and the first retinal image 82 has a second image resolution of a first virtual image location 71 when optical eye axis is substantially coincident with first field axis 72. In some embodiments, the second image resolution may be greater than the first image resolution. Stated another way, the first retinal image 82 may have a greater image resolution when eye 80 is rotated to align with first field axis 72 than when eye 80 is aligned with optical system axis 10.

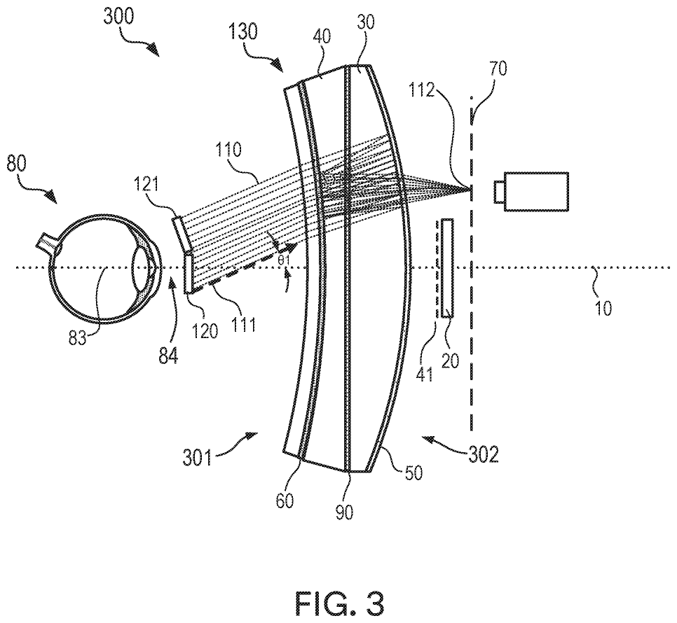

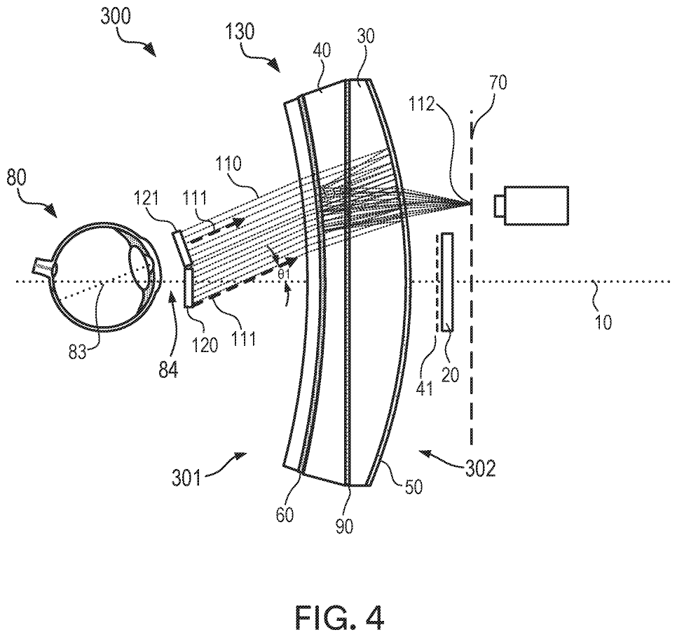

FIGS. 3 and 4 provide side views of a foveated optical lens as part of an optical system, according to the present description. FIGS. 3 and 4 show essentially the same optical system, but with the eye 80 at two different angles of rotation. FIGS. 3 and 4 should be viewed together for the following discussion. Like-numbered components common to both FIGS. 3 and 4 shall be assumed to have the same function and description unless otherwise specified herein.

Optical system 300 includes an optical system axis 10, a lens assembly 130, and a display 20. In some embodiments, the lens assembly 130 has an eye-side 301 configured to be disposed proximate an eye 80 of a viewer, and a display-side 302 configured to be disposed proximate the display 20. In some embodiments, the lens assembly 130 includes a first lens component 30 disposed closer to display 20 and a second lens component 40 disposed proximate first lens component 30 on an opposing side (i.e., the side facing away from display 20). In some embodiments, the lens assembly 130 may further include a partial reflector 50 disposed on a side of first lens component 30 closest to display 20 (e.g., on the display-side 302), an optical retarder disposed between first lens component 30 and second lens component 40, and a reflective polarizer 60 disposed on a side of the second lens component 40 closest to eye 80 (e.g., on the eye-side 301). In some embodiments, the optical system 300 is configured to display a virtual image 70 of an image 41 emitted by display 20 to the eye 80 of the viewer.

In some embodiments, a substantially collimated light 110 propagates along a first direction 111. First direction 111 makes a first angle θ1 with the optical system axis 10. In some embodiments, first angle θ1 may be between about 5 degrees and about 30 degrees. When substantially collimated light 110 illuminates optical system 300 from the eye-side 301 and enters the optical system 300, and substantially fills, a field stop 120/121 positioned proximate the eye-side 301, light 110 focuses to a focal spot 112 after going through lens assembly 130 and exiting optical system 300 from the display-side 302.

In some embodiments, when eye 80 is positioned proximate eye-location 84, focal spot 112 may have a first minimum size when the field stop 120/121 is substantially centered on optical system axis 10 (in position 120, with eye 80 rotated as shown in FIG. 3), and focal spot 112 may have a second minimum size when the field stop 120/121 is rotated about a first center 83 proximate a center of the eye 80 of the viewer (in position 121, with eye 80 rotated as shown in FIG. 4) so that the field stop 120/121 is substantially perpendicular to first direction 111. In some embodiments, the second minimum size may be smaller than the first minimum size. In some embodiments, the maximum dimension of field stop 120/121 may be based on a nominal size of an adult, human pupil. In some embodiments, a maximum dimension of field stop 120/121 may be between about 2 millimeters (mm) and about 8 mm.

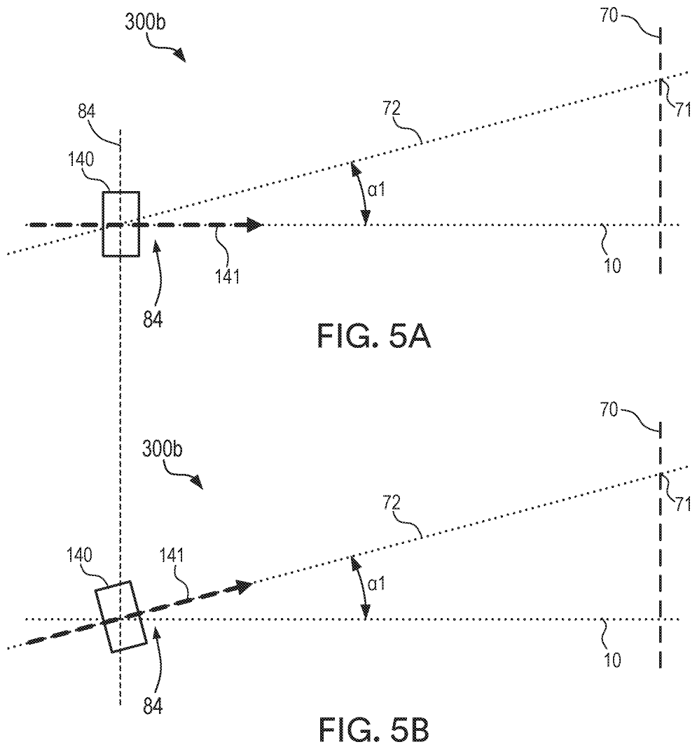

FIGS. 5A and 5B provide visual depictions of optical axes for an optical system such as optical system 300 of FIG. 1, in which the eye 80 of a viewer has been replaced with an imaging system 40 (e.g., a camera with an objective lens capable of focusing on the virtual image) centered on an imaging system axis 141. For simplicity, as was done with FIGS. 2A and 2B described elsewhere herein, the lenses (the at least one lens) and the display shown in FIG. 1 have been omitted, and, accordingly, the partial optical system shown is relabeled 300b. Components shown in FIGS. 5A and 5B have a common function and/or purpose as like-numbered components in other figures herein unless otherwise specified.

Optical system 300b includes an optical system axis 10, a display (such as display 20, as shown in FIG. 1), and at least one lens (such as lens components 30 and 40, shown in FIG. 1). In some embodiments, optical system 300b may form a virtual image 70 for viewing by an eye (such as eye 80, shown in FIG. 1) when the eye is positioned proximate eye-location 84. In some embodiments, for each first virtual image location 71 at a first field angle α1, when an imaging system 140 is, centered on imaging system axis 141, is positioned proximate the eye-location 84 and forms an image of the virtual image 70 corresponding to the first virtual image location 71, a resolution of the formed virtual image 70 may increase as the imaging system 140 is rotated so that the imaging system axis 141 moves away from being coincident with optical system axis 10 and approaches first field angle α1 (i.e., as it rotates up and approaches becomes substantially coincident with a first field axis 72 extending between the imaging system 140 and the first virtual image location 71 at first field axis al).

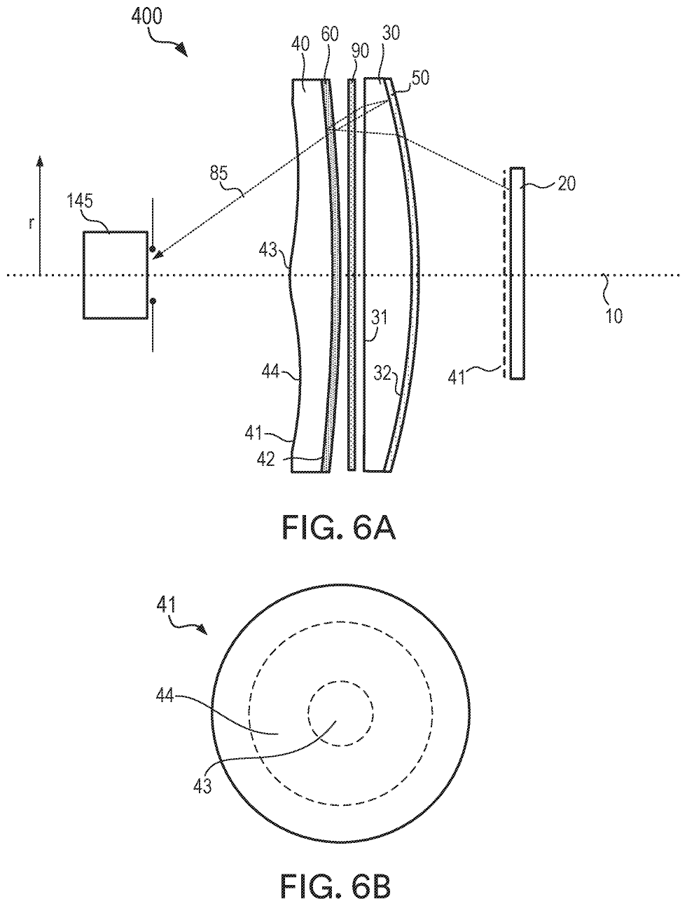

FIGS. 6A and 6B provide details on one embodiments of an optical system which includes lenses with specifically defined surface curves. Optical system 400 may be any of the optical systems discussed herein, including optical system 300 of FIGS. 1 and 4, optical system 300a of FIGS. 2A and 2B, and optical system 300b of FIGS. 5A and 5B.

In some embodiments, optical system 400 may include a first optical lens 40 and a second optical lens 30. In some embodiments, first optical lens 40 includes first major surface 41 and an opposing second major surface 42. In some embodiments, second optical lens 30 includes third major surface 31 and an opposing fourth major surface 32. In some embodiments, the second major surface 42 of first optical lens 40 and the third major surface 31 face each other. In some embodiments, the first major surface 41 may include a convex central portion 43 surrounded by an annular concave outer portion 44. FIG. 6B provides a front view of first major surface 41 identifying convex central portion 43 and annular concave outer portion 44, for one embodiment. In some embodiments, the second major surface 42 may be convex, the third major surface may be substantially planar, and the fourth major surface may be convex.

In some embodiments, optical system 400 may further include one or more of a partial reflector 50 (e.g., a 50/50 beamsplitter coating or film), a reflective polarizer 60, and an optical retarder 90 (e.g., a quarter-wave plate). In such embodiments, partial reflector 50 may be disposed on fourth major surface 32 of second optical lens 30, reflective polarizer may be disposed on second major surface 42 of first optical lens 40, and optical retarder 90 may be disposed between second major surface 42 of first optical lens 40 and third major surface 31 of second optical lens 30. In such embodiments, where one or more of the partial reflector 50, reflective polarizer 60, and optical retarder 90 are present, the optical system axis 10 may be folded (e.g., reflected one or more times from one or more surfaces of the lenses and reflective films) such as shown by light path 85 in FIG. 6A. That is, light 85 emitted by image 41 of display 20 may be redirected multiple times passing through optical system 400 before reaching optical perceiving system 145 (e.g., an imaging system such as 140 in FIG. 5, or the eye of a viewer 80 as shown in FIG. 1).

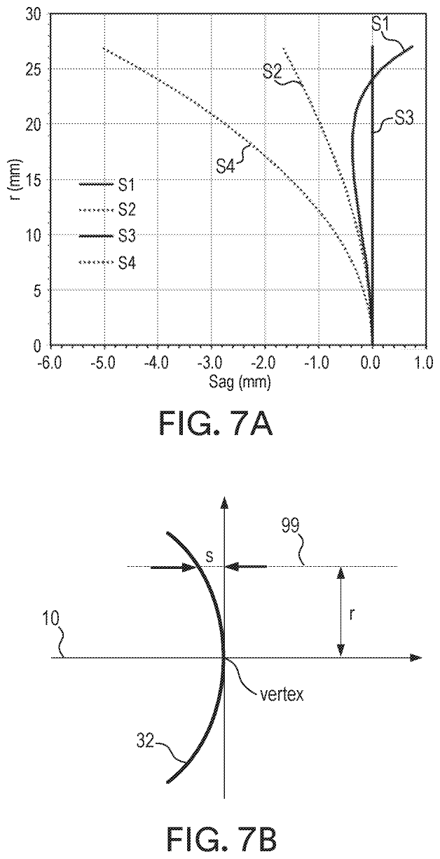

In some embodiments, the first through fourth major surfaces (41, 42, 31, 32) may have respective sags S1-S4, wherein each of the sags is defined by:

$$S = \frac{c {r}^{2}}{1 + \sqrt{1 - ( 1 + k ) {c}^{2} {r}^{2}}} + {α}_{2} {r}^{4} + {α}_{3} {r}^{6} + {α}_{4} {r}^{8}$$

where c is 1/radius of curvature of the major surface, k is the conic constant of the surface, r is a distance from the optic axis, and a is an aspheric deformation constant. FIG. 7A shows example sag definitions for one embodiment of optical system 400. S1 corresponds to the defined sag of first major surface 41, S2 corresponds to the defined sag of second major surface 42, S3 corresponds to the defined sag of third major surface 31, and S4 corresponds to the defined sag of fourth major surface 32.

FIG. 7B provides a definition for sag, s, as used in FIG. 7A. As used herein, sag, s, applies to either the convex or concave curvature of a lens and represents the physical distance, r, between the vertex (highest or lowest point of the curve) along the curve and the center point of a line 99 drawn perpendicular to the curve. Sag, s, may also be referred to as sagittal depth for a given point on the curve.

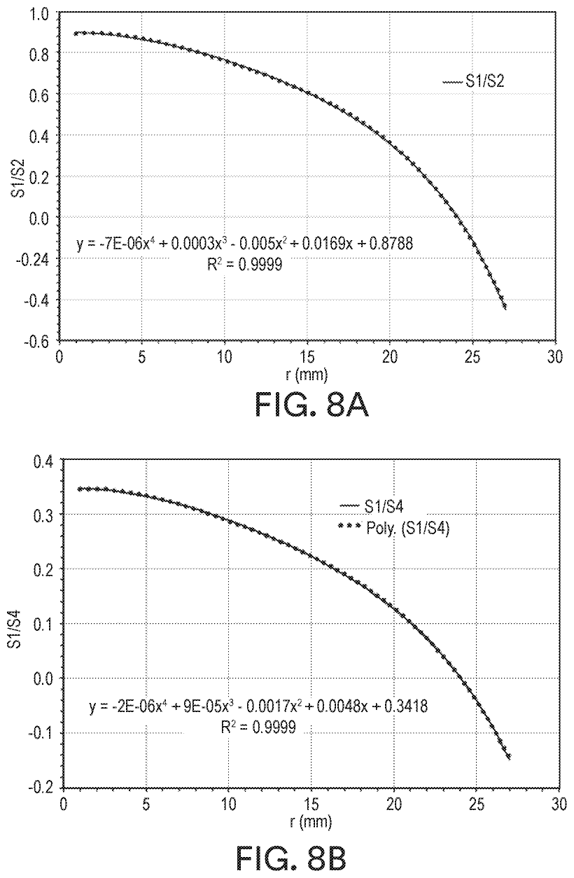

Finally, FIGS. 8A and 8B define the relationships between some of the sag values for the major curves of first optical lens 40 and second optical lens 30 of FIG. 6A. FIG. 8A shows a plot of S1/S2 (that is, the S1 sag of first major surface 41 divided by the S2 sag of second major surface 42) for one embodiment of the optical system. FIG. 8A shows a plot of S1/S4 (that is, the S1 sag of first major surface 41 divided by the S4 sag of fourth major surface 32). In some embodiments, for a value of r extending from about 1 mm to at least about 25 mm:

$$- 0.7 \leq S 1 / S 2 \leq 1 , and - 0.2 \leq S 1 / S 4 \leq 0.4 .$$

In some embodiments, a best fourth-order polynomial fit to each of the S1/S2 and S1/S4 has an r-squared value greater than about 0.95. See, for example, the plot of best fourth-order polynomial fit shown in FIG. 8B (substantially identical to the plot of S1/S4).

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optical system comprising an optical system axis, a display and at least one lens, the optical system forming a virtual image of an image emitted by the display for viewing by an eye, the eye having an optical eye axis, such that a first retinal image of the virtual image at a first virtual image location and an associated first field angle, the first field angle between about 5 degrees and about 30 degrees, has a first image resolution when the eye axis is substantially coincident with the system axis, and a second image resolution when the eye is rotated so that the eye axis is substantially coincident with a first field axis extending between the eye and the virtual image at the first field angle, wherein the second image resolution is greater than the first image resolution.

2. The optical system of claim 1, wherein the at least one lens comprises a first optical lens comprising opposing first and second major surfaces and facing a second optical lens comprising opposing third and fourth major surfaces, the second and third major surfaces facing each other, the first through fourth major surfaces having respective sags S1-S4, wherein each of the sags is defined by:
$$S = \frac{c {r}^{2}}{1 + \sqrt{1 - ( 1 + k ) {c}^{2} {r}^{2}}} + {α}_{2} {r}^{4} + {α}_{3} {r}^{6} + {α}_{4} {r}^{8}$$
where c is 1/radius of curvature of the major surface, k is a conic constant of the surface, r is a distance from the optical system axis, and a is an aspheric deformation constant,
wherein the first major surface comprises a convex central portion surrounded by an annular concave outer portion, the second major surface is convex, the third major surface is substantially planar, and the fourth major surface is convex,
wherein for r extending from about 1 mm to at least about 25 mm:
$$- 0.7 \leq S 1 / S 2 \leq 1 ;$$
$$- 0.2 \leq S 1 / S 4 \leq 0.4 ;$$
and
a best fourth-order polynomial fit to each of the S1/S2 and S1/S4 has an r-squared value greater than about 0.95.

3. The optical system of claim 1, wherein the second image resolution is greater than the first image resolution for all first field angles between about 5 degrees and about 30 degrees.

4. The optical system of claim 1 further comprising one or more of a partial reflector, a reflective polarizer, and an optical retarder.

5. The optical system of claim 1, wherein the optical system axis is folded.

6. The optical system of claim 1, wherein the optical system axis is folded so that a first segment of the system axis substantially coincides with a different second segment of the system axis.

7. An optical system comprising an optical system axis, a lens assembly comprising at least one lens, an eye-side configured to be disposed proximate an eye of a viewer, and a display-side configured to be disposed proximate a display, the optical system configured to display a virtual image of an image emitted by the display to the eye of the viewer,
such that when a substantially collimated light that propagates along a first direction making a first angle of between about 5 degrees and about 30 degrees with the optical system axis illuminates the optical system from the eye-side of the optical system and enters the optical system through, and substantially fills, a field stop positioned proximate the eye-side of the optical system, and focuses to a focal spot after going through the lens assembly and exiting the optical system from the display-side thereof, the focal spot has a first minimum size when the field stop is substantially centered on the optical system axis and a second minimum size when the field stop is rotated about a first center proximate a center of the eye of the viewer so that the field stop is substantially perpendicular to the first direction, the second minimum size being smaller than the first minimum size.

8. The optical system of claim 7, further comprising one or more of a partial reflector, a reflective polarizer, and an optical retarder.

9. The optical system of claim 7, wherein the optical system axis is folded.

10. The optical system of claim 7, wherein the optical system axis is folded so that a first segment of the optical system axis substantially coincides with a different second segment of the optical system axis.

11. The optical system of claim 7, wherein the field stop has a size of between about 2 mm and about 8 mm.

12. The optical system of claim 7, wherein the field stop has a size of between about 3 mm and about 7 mm.

13. An optical system comprising an optical system axis, a display and at least one lens, the optical system forming a virtual image of an image emitted by the display for viewing by an eye when the eye is positioned proximate an eye-location on an eye-side of the optical system,
such that for each first virtual image location at a first field angle of between about 5 degrees and about 30 degrees relative to the system axis, when an imaging system centered on an imaging system axis is positioned proximate the eye-location and forms a formed image of the virtual image corresponding to the first virtual image location, a resolution of the formed image increases as the imaging system is at least rotated so that the imaging system axis approaches the first field angle.

14. The optical system of claim 13, wherein the imaging system is a camera with an objective lens capable of focusing on the virtual image.

15. The optical system of claim 13 further comprising one or more of a partial reflector, a reflective polarizer, and an optical retarder.

16. The optical system of claim 13, wherein at least a first lens in the at least one lens is a Fresnel lens comprising a structured major surface.

17.-20. (canceled)
